(19) United States
(12) Patent Application Publication
(10) Pub. No.: US 2023/0030658 A1
(43) Pub. Date: Feb. 2, 2023

(54) EMULSIFIED FOOD FORMULATION

(71) Applicant: BARILLA G. E R. FRATELLI S.P.A., Parma (IT)

(72) Inventors: Fabrizio CASSOTTA, Lodi (IT); Vincenzo DE TATA, Parma (IT); Alessandro D'ALESSANDRO, Parma (IT)

(73) Assignee: BARILLA G. E R. FRATELLI S.P.A., Parma (IT)

(21) Appl. No.: 17/758,472

(22) PCT Filed: Feb. 22, 2021
(86) PCT No.: PCT/EP2021/054263

§ 371 Date: Jul. 7, 2022

(30) Foreign Application Priority Data
Feb. 27, 2020 (IT) 102020000004060

(51) Int. Cl. A23L 35/00; A23L 19/00; A23L 25/00; A23L 29/00; A23L 33/22

(52) U.S. Cl. CPC A23L 35/10; A23L 19/09; A23L 25/30; A23L 29/04; A23L 33/22

(57) ABSTRACT

A ready-to-use emulsified food formulation containing a vegetable in a finely divided form, vegetable oil, water, and an oleaginous seed in a finely divided form and, present in an amount of between 0.1% and 15% by weight, is disclosed. The emulsified food formulation is free of thickeners, emulsifiers and stabilizers and is obtained by homogenization carried out at a pressure greater than or equal to 10000 kPa. The emulsified food formulation is characterized by having a modal diameter of the particles contained therein of greater than or equal to 300 μm and by containing a vegetable fiber in a finely divided form having a fiber content of greater than (70)% w/w and a water binding capacity of greater than 5 g water/g dry matter.

### FIELD OF APPLICATION

The present invention refers to the sector of the food industry.

In particular, the invention relates to an emulsified food formulation, being suitable to be used as a condiment for salads and cold dishes, or as a spreadable cream for garnishing or filling bread and similar bakery products and/or as an accompaniment for dishes of various kinds.

### PRIOR ART

It is known that industrially prepared condiments, for example ready-made sauces and dressings, are widely used by consumers because they are ready-to-use food products and are easily storable at room temperature or refrigerated.

It is also known that, over time, such condiments can undergo degradation phenomena which, generally, concern the physical stability of the product.

In fact, most of the industrially prepared condiments comprise an aqueous phase and an oil phase, emulsified with each other, which as the storage period progresses show the tendency to separate from each other.

This phenomenon can be associated with a perception of deterioration or, more generally, with a loss of genuineness of the food product by the consumer.

In the sector, it is known to add specific products such as thickeners, stabilizers and emulsifiers (indicated with codes E400-E499 on the labels of condiments according to the classification of the European Food Safety Authority, EFSA), in order to counteract and slow down this separation phenomenon of the oil phase from the aqueous phase.

In particular, thickeners have the purpose of thickening the condiment to guarantee a sufficiently compact consistency, while emulsifiers and stabilizers have the function of delaying as much as possible the separation of the aqueous phase from the oil phase during the storage period of the condiment.

A further critical aspect of an industrially prepared condiment is the storage duration at room temperature (20° C.), known also as “shelf-life”.

The shelf-life is notoriously not only correlated with the physical stability, but also with the chemical and microbiological stability of the food; for this reason, industrially prepared food products also comprise preservatives (E200-299) and antioxidants (E300-399), whose function is to minimize the possibility of spreading bacteria and/or fungi which damage and deteriorate the food product.

CN 108013148 relates to a drink made of peanut milk, containing in suspension solid particles of peanuts, coconut, walnuts and/or hazelnuts; the suspension contains different stabilizers including citrus fiber, microcrystalline cellulose, carboxymethylcellulose, mono- and diglycerides and xanthan gum.

CN 107079995 relates to a drink with lactic acid bacteria containing mushroom extract, which contains various ingredients including citrus fiber and pulverized pine nuts, as well as at least one stabilizing agent, such as for example pectin, carboxymethylcellulose and xanthan gum.

WO 2020/002345 relates to a ready-to-use food formulation in the form of oil-in-water emulsion, which can be stored at a temperature comprised between 2° C. and 30° C. for at least two weeks, and which comprises at least one vegetable in comminuted form (for example basil), vegetable oil and at least one protein concentrate derived from oleaginous seeds, salt, sugar and natural flavourings. The emulsified formulation has a rotational viscosity higher than 150 Pa*s, a pH between 3.7 and 5, and a value of water activity not higher than 0.95. This formulation does not comprise added vegetable fibers.

WO 2012/089448 describes oil-in-water acidified emulsions that have been stabilized by incorporation of a small quantity of finely ground pulse seeds in the emulsion; such emulsions can be obtained by mixing the aqueous and oil phases in conventional mixers under condition of reduced shear, for example 4500 rpm or less. This formulation comprises neither oleaginous seeds nor added vegetable fibers.

EP 3 578 062 relates to an emulsified condiment comprising pulses and oleaginous seeds (for example almonds) in form of fine particles, an oil or a fat, an organic acid (having acidifying and preservative activities, for example acetic acid) and optionally a vegetable. This condiment has a particle modal diameter comprised between 0.3 and 100 μm and does not comprise added vegetable fibers.

However, the stabilizing agents, as well as the preservative agents, added to the industrially prepared condiments are not positively perceived by the consumer, who is increasingly attentive to and concerned about the healthiness and genuineness of the used ingredients, and who is looking in particular for “clean label” products, i.e. without food additives.

Therefore, the technical problem underlying the present invention is to provide a food formulation which remains substantially unaltered from the point of view of the physical and microbiological stability during its shelf life, which is “clean label”, i.e. free of food additives, thereby overcoming the problems encountered in the prior art.

### SUMMARY OF THE INVENTION

This technical problem is solved, according to the present invention, by a ready-to-use emulsified food formulation, being free of food additives consisting of thickeners, emulsifiers and stabilizers, comprising at least one vegetable in a finely divided form, vegetable oil, water and at least one oleaginous seed in a finely divided form, wherein said oleaginous seed is present in a quantity comprised between 0.1% and 15% by weight of the total weight of the formulation, said emulsified food formulation being obtained by homogenization carried out at a pressure equal to or higher than 10000 kPa and being characterized by a modal diameter of the particles contained therein higher than or equal to 300 μm and by additionally containing a vegetable fiber in a finely divided form, having a fiber content higher than 70% w/w and a water binding capacity higher than 5 g water/g dry matter.

The above-mentioned vegetable fiber in a finely divided form preferably has a humidity content less than 10%.

The above-mentioned fiber content is preferably comprised between 75% and 80% w/w and the water binding capacity measured by an internal method inspired by the official method AACC 56-37.01, is preferably comprised between 6.0 and 28.0 g water/g dry matter.

The modal diameter of the particles contained in the formulation measured by the light scattering method is preferably comprised between about 300 and 1500 micrometers, advantageously between 700 and 900 micrometers.

The expressions “oleaginous seeds” or “shell fruit”, used herein interchangeably, are understood as meaning seeds and/or fruits without husk and pericarp, which are ripe and have undergone drying, and which comprise almonds, hazelnuts, walnuts, cashews, pecan nuts, macadamia nuts, pistachios, peanuts, pine nuts, hemp seeds, sunflower seeds, pumpkin seeds, flax seeds, and chia seeds.

The food formulation according to the present invention is “free of food additives consisting of thickeners, emulsifiers and stabilizers”, meaning by this expression all thickeners, emulsifiers and stabilizers not of natural origin which are conventionally added to industrial food preparations.

Preferably, the above-mentioned homogenization is carried out at a pressure comprised between 15000 kPa and 30000 kPa.

Preferably, the at least one vegetable fiber in a finely divided form is selected from the group comprising citrus fiber, apple fiber, pea fiber, potato fiber, carrot fiber and rice fiber, and has an average particle size equal to or less than 1500 μm.

Preferably, the at least one oleaginous seed in a finely divided form is selected from the group comprising almond, cashew, pistachio, hazelnut, walnut, pecan nut, macadamia nut, pine nuts, hemp seeds, sunflower seeds, pumpkin seeds, flax seeds and chia seeds, peanuts, and has an average particle size equal to or less than 1500 μm.

According to a preferred embodiment of the present invention, the vegetable fiber is citrus fiber and the oleaginous seed is cashew.

According to another equally preferred embodiment of the present invention, the vegetable fiber is apple fiber, and the oleaginous seed is almond.

Preferably, the at least one vegetable in a finely divided form is selected from the group consisting of basil, parsley, thyme, marjoram and oregano and it is more preferably basil.

Preferably, the at least one vegetable in a finely divided form is present in a quantity comprised between 10% and 15% by weight of the total weight of the formulation and has an average particle size equal to or less than 1500 μm.

Preferably, the vegetable oil is selected from sunflower oil, corn oil, rice oil, sesame oil, peanut oil and olive oil, in particular extra virgin olive oil, and it is more preferably sunflower oil.

Preferably, the vegetable oil is present in a quantity comprised between 10% and 15% by weight of the total weight of the formulation.

Preferably, the above-mentioned food formulation further comprises at least one ingredient selected from salt, sugars, starches, vegetable proteins, legumes, garden vegetables, leafy greens (in particular chards, spinaches, cabbages, escarole) cereals and natural flavourings.

Preferably, the above-mentioned food formulation further comprises at least one acidifying ingredient selected from the group consisting of citrus juices, more preferably concentrated citrus juices, and vinegar, more preferably selected from apple cider vinegar, balsamic vinegar, honey vinegar, white wine vinegar and red wine vinegar.

Preferably, the above-mentioned food formulation has a rotational viscosity greater than 80 Pa·s, more preferably greater than 115 Pa·s, at a temperature of 22° C.

Preferably, the above-mentioned food formulation is characterized by a pH comprised between 3.0 and 5.0, more preferably between 3.5 and 3.9, and by a value of water activity (a_{w}) higher than or equal to 0.95, preferably comprised between 0.95 and 0.99.

Preferably, the food formulation as defined above is storable at a temperature comprised between 2° C. and 30° C. for a time period of at least two weeks, preferably for 24 months.

In another aspect thereof, the present invention also relates to the use of a food formulation as defined above as a condiment.

Therefore, the present invention relates to a ready-to-use emulsified food formulation, being free of food additives consisting of thickeners, emulsifiers and stabilizers, which comprises at least one vegetable in a finely divided form, vegetable oil, water, at least one vegetable fiber in a finely divided form and at least one oleaginous seed in a finely divided form, as defined above.

Advantageously, the vegetable fiber contained in the present formulation provides a sufficiently thick consistency to the present formulation, thus making it suitable for its use as a condiment.

“Citrus fiber” is understood as meaning a fiber obtained by citrus fruits selected from orange, lime, lemon and grapefruit; example of commercially available citrus fibers which can be used in the formulation of the present invention are HERBACEL® AQ® Plus Citrus and Citri-Fi® 100.

Advantageously, the finely divided oleaginous seed contained in the present formulation acts as a natural emulsifier, significantly slowing down the phenomenon of separation of the oil phase from the aqueous phase.

Advantageously, the present formulation is obtained by subjecting the mixture of the above-mentioned ingredients to a high-pressure homogenization step (equal to or higher than 10000 kPa).

The expression “high-pressure homogenization”, as used herein, means a process of homogenization during which a process fluid is subjected to extremely intense fluid-mechanical stresses, which cause the particles suspended in the liquid to break into smaller fragments, down to micrometric and nanometric sizes.

Advantageously, the high-pressure homogenization applied to the formulation of the invention guarantees the stability of the emulsion as well as a uniform distribution of the suspended solid particles in the oil and aqueous phases.

In particular, this technique contributes to significantly slowing down the phenomenon of separation of water or oil from the present formulation, during the storage period.

On the contrary, as shown in detail below, a homogenization at low-pressure of the same formulation does not prevent this phenomenon from occurring during the storage period.

The expression “[ingredient] in a finely divided form”, as used herein, means the ingredient in question (vegetable fiber or oleaginous seed) after it has been subjected to mechanical grinding (for example by means of colloidal mills, cutters, immersion homogenizers) and subsequently to high-pressure homogenization, as defined above, and therefore has a particle size equal to or less than 1500 micrometers (μm), preferably from 1 to 500 micrometers.

The combination of the vegetable fiber and the oleaginous seed in the food formulation of the invention, together with the fact that the formulation itself is subjected to high-pressure homogenization, thus allows to emulsify the oil phase comprising the above-mentioned vegetable oil in the aqueous phase made of water and the water-soluble substances dissolved therein and, furthermore, allows to effectively stabilize the formulation from a physical point of view (consistency and viscosity).

In fact, preferably, the food formulation according to the present invention advantageously has a rotational viscosity higher than 80 Pas, more preferably higher than 115 Pas at a temperature of 22° C.

According to the present invention, these values of rotational viscosity were determined by means of a rheometer MCR-101 Anton Paar 0 (temperature 22° C., shear rate 1 s⁻¹).

The measurement is carried out directly on a jar containing the formulation according to the invention, subjecting the formulation, previously thermostated at 22° C., to a rotational stress (at a constant share rate at 1 s⁻¹) by a paddle measuring system which is rotated inside the jar at a predetermined and constant height.

The present formulation advantageously comprises other ingredients, including at least one vegetable in a finely divided form, preferably consisting of basil leaves.

The expression “basil leaves”, as used herein, means leaves of plant specimens belonging to any variety of the species Ocimum basilicum, according to the Linneo classification.

The expression “concentrated citrus juice”, as used herein, means the juice extracted from citrus fruits (for example lemon, lime, orange, grapefruit), used in the present formulation to balance the taste (mainly acidity and sweetness) and control the pH (acidifying effect).

In accordance with a preferred embodiment, the food formulation according to the present invention may have the following general recipe, in which the percentages are to be regarded as expressed by weight relative to the overall weight of the formulation:

| | |
|---|---|
| Basil | 10-15% |
| Vegetable oil | 10-15% |
| Oleaginous seed | 4-8% |
| Concentrated citrus juice | 8-12% |
| Vegetable fiber | 0.2-0.5% |
| Salt | 0.5-1.5% |
| Water | q.s. at 100% |

In order to ensure the microbiological stability during the whole storage period of the food formulation, which is free of antimicrobial and preservative agents, the formulation is subjected to a pasteurization heating treatment.

Preferably, this pasteurization treatment occurs at high temperatures (90-100° C.) and for a time period sufficient to reduce the microbiological growth of the mixture, without compromising the organoleptic characteristics of each ingredient used for the formulation itself.

Ultimately, in an entirely advantageous manner, the food formulation according to the present invention is particularly suitable for the use as a condiment for salads and cold dishes, together with other ingredients or also on its own.

Furthermore, thanks to its particular characteristics of creamy consistency and viscosity, the food formulation according to the present invention is also particularly suitable for topping or filling for bread, pizza and similar bakery products and/or as an accompaniment for dishes of various kinds, for example starters, side dishes or main courses.

The present invention also relates to the use of a food formulation as described above as a condiment.

Advantageously, the above-mentioned use of the ready-to-use food formulation according to the invention is particularly convenient during the whole shelf life of this product, without the need for any further treatment such as mechanical processing or cooking.

Further features and advantages of the present invention will emerge from the description, provided hereinbelow, of an embodiment of the food formulation according to the present invention, provided by way of an indicative and non-limiting example with reference to the attached drawings.

### BRIEF DESCRIPTION OF THE DRAWINGS

FIG. 1 refers to a series of photographs which show how the stability of a same emulsified food formulation changes by varying the homogenization conditions and the concentration of the oleaginous seed (cashews) contained in the formulation.

FIG. 2 is an image of the formulation according to Example 2 of the present invention, obtained by the optical microscope Eclipse E400 Nikon ®, 10× objective lens.

FIG. 3 shows a graph of the modal distribution of the diameter of the particles contained in the formulation according to Example 2.

### DETAILED DESCRIPTION

### EXAMPLE 1

### Example of Formulations According to the Present Invention

Some examples of recipes of the emulsified food formulation according to the present invention are reported below:

| | Ingredient | weight (g) |
|---|---|---|
| Recipe a) | Water | 60 |
| | Basil leaves | 13 |
| | Sunflower oil | 11.7 |
| | Cashews | 5 |
| | Concentrated lemon juice | 9 |
| | Citrus fiber | 0.30 |
| | (HERBACEL ® AQ ® Plus Citrus) | |
| | Salt | 1 |
| Recipe b) | Water | 59.3 |
| | Basil leaves | 13 |
| | Sunflower oil | 11.7 |
| | Almonds | 5 |
| | Concentrated orange juice | 9 |
| | Apple fiber | 1 |
| | Salt | 1 |
| Recipe c) | Water | 60 |
| | Oregano leaves | 13 |
| | Sunflower oil | 11.6 |
| | Pistachios | 5 |
| | Concentrated lime juice | 9 |
| | Citrus fiber | 0.40 |
| | (HERBACEL ® AQ ® Plus Citrus) | |
| | Salt | 1 |
| Recipe d) | Water | 59.6 |
| | Parsley leaves | 13 |
| | Corn oil | 11.7 |
| | Cashews | 5 |
| | Concentrated lemon juice | 9 |
| | Pea fiber | 0.70 |
| | Salt | 1 |

### EXAMPLE 2

### Method of Production of a Food Formulation According to the Present Invention

Below is shown an example process for obtaining a ready-to-use emulsified formulation according to the invention starting from recipe a) according to the above-shown Example 1.

Among the ingredients listed in the above-mentioned recipe a), the fresh basil leaves were initially washed.

About 2% w/w of the basil leaves were isolated and set aside for later addition.

Sunflower oil, concentrated lemon juice, citrus fiber (HERBACEL® AQ® Plus Citrus), salt and cashews were then added to the remaining part of the basil leaves in a colloidal mill (model MZ 80, Frymakoruma®, motor rotation speed 2888 min⁻¹).

The outer element of the colloidal mill (that is the stator) was fixed, while the internal cone (the rotor) was moving at high speed.

Crushing was caused by a simultaneous cutting and rubbing action of the material moving through the grooves of the surfaces and by an induced action of high-frequency vibration. These actions exerted high pressure-tensile forces on the product particles so that they were crushed and ripped. An intense vortex inside the grinding passage and the action connected thereto determine the high crushing, mixing and homogenizing power operated by the colloidal mill. The basil leaves and cashews are thus comminuted and simultaneously mixed with the sunflower oil and the other ingredients.

Subsequently, the mixture was introduced into the NS2006 L homogenizer by the company GEA Niro Soavi®, at a feed rate of 40 litres/hour, and was treated according to the following steps:
First homogenization stage at 12000 kPa, at 40° C. and 40 litres/hour;
Second homogenization stage at 28000 kPa, at 40° C. and 40 litres/hour.

The resulting homogenized emulsified formulation had an average particle size equal to about 500 μm.

The previously isolated fraction of basil leaves, which was later roughly ground in order to keep the visibility of the basil leaves in the end product, was then added to such formulation.

At the end of this phase, the emulsified formulation was heated at 95° C., dosed inside glass jars, which were then sealed with a specific metal safety cap and immersed in boiling water (98° C.) for 30 minutes, so as to obtain the complete pasteurization of the formulation.

The thus-obtained formulation appeared as a viscous fluid with creamy and uniform consistency, characterized by an overall intense green and non-transparent colour.

The uniformity of the particle dispersion of basil, cashew and citrus fiber was verified by an optical microscope Eclipse E400 Nikon ®, 10× objective lens (FIG. 2).

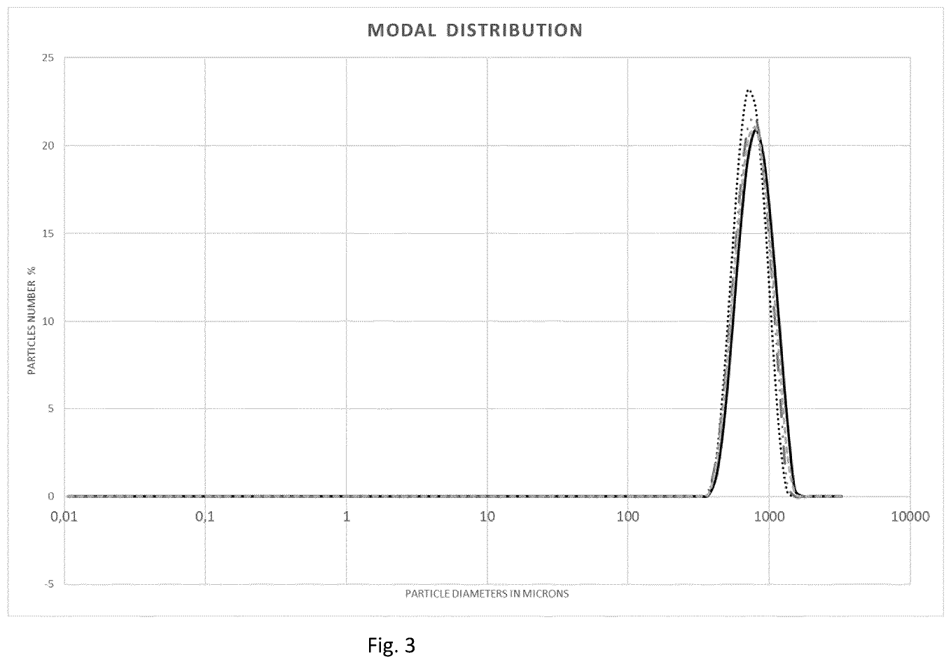

The modal diameter distribution of the particles contained in the formulation is shown in FIG. 3.

### EXAMPLE 3

### Comparative Test

A comparative test was carried out between a formulation according to the invention (I) and formulations not according to the invention (II, III and IV), according to the following recipes, in order to evaluate whether, by varying the parameters of the type of homogenization and the quantity of an oleaginous seed incorporated in the formulation according to the invention, the latter showed changes from the point of view of the physical stability, by particularly analysing the phenomenon of the separation of the aqueous phase from the oil phase.

The tested samples were obtained according to the procedure described in Example 2, starting from ingredients as specified below for each sample and by applying specific homogenization steps according as follows :
Formulation I (according to the present invention): water 50 g, basil 13 g, sunflower oil 15 g, cashews 6 g, citrus fiber (HERBACEL® AQ® Plus Citrus) 0.5 g; subjected to high-pressure homogenization (280 bar) by homogenizer NS2006 L by the company GEA Niro Soavi®.
Formulation II (not according to the invention): water 56 g, basil 13 g, sunflower oil 15 g, citrus fiber (HERBACEL® AQ® Plus Citrus) 0.5 g; subjected to the high-pressure homogenization (280 bar) by homogenizer NS2006 L by the company GEA Niro Soavi.
Formulation III (not according to the invention): water 56 g, basil 13 g, sunflower oil 15 g, citrus fiber (HERBACEL® AQ® Plus Citrus) 0.5 g; subjected to a simple grinding by a household blender (speed 10000 rpm).
Formulation IV (not according to the invention): water 50 g, basil 13 g, sunflower oil 15 g, cashews 6 g, citrus fiber (HERBACEL® AQ® Plus Citrus) 0.5 g; subjected to a simple grinding by a household blender (speed 10000 rpm).

The formulations I and IV comprise 6 g of cashews (6% by weight of the total weight of the formulation), while the formulations II and III are free of any oleaginous seeds.

The formulations I and II were moreover obtained by high-pressure homogenization, while the formulations III and IV were homogenized by a household kitchen blender.

All samples were placed in glass jars, sealed and kept at room temperature (25°) for 15 days.

At the end of this time period, the stability of the samples was evaluated from a physical point of view.

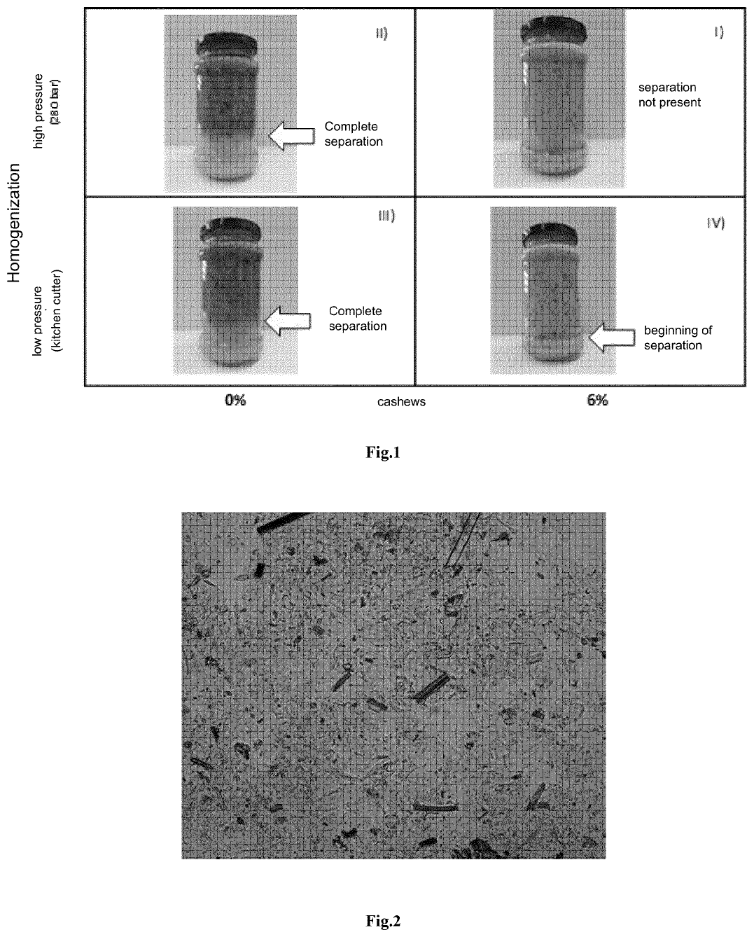

As can be well seen from FIG. 1, the only tested formulation which maintains physical stability at the end of the 2 weeks period was the formulation according to the present invention (formulation I), containing 6% cashews and subjected to a step of high-pressure homogenization (280 bar).

On the contrary, formulations II and III, which were free of oleaginous seeds, showed a distinguishable separation of the aqueous phase from the fat phase, although in particular formulation II was subjected to high-pressure homogenization.

The formulation IV, which contained 6% of cashews but obtained by homogenization by a household kitchen blender, showed a beginning of separation of the aqueous phase from the fat phase.

It is therefore clear that only the high-pressure homogenization of a formulation containing a vegetable fiber and an oleaginous seed, as defined in the above-mentioned formulation I, guarantees the physical stability of the formulation for its entire shelf-life at room temperature.

1. A ready-to-use emulsified food formulation, being free of food additives consisting of thickeners, emulsifiers and stabilizers, comprising a vegetable in a finely divided form, vegetable oil, water, and a oleaginous seed in a finely divided form,
wherein said oleaginous seed is present in a quantity of between 0.1% and 15% by weight of the total weight of said formulation,
said emulsified food formulation being obtained by homogenization carried out at a pressure equal to or higher than 10000 kPa and having a modal diameter of the particles contained therein greater than or equal to 300 μm and by additionally containing a vegetable fiber in a finely divided form, having a fiber content greater than 70% w/w and a water binding capacity greater than 5 g water/g dry matter.

2. The food formulation according to claim 1, wherein said vegetable fiber in a finely divided form has a humidity content less than 10%.

3. The food formulation according to claim 1, wherein the fiber content of said vegetable fiber is between 75% and 80% w/w and the water binding capacity of said vegetable fiber is between 6.0 and 28.0 g water/g dry matter.

4. The food formulation according to claim 1, wherein the modal diameter of the particles contained in said formulation is between about 300 and 1500 micrometers.

5. The food formulation according to claim 1, wherein said homogenization is carried out at a pressure of between 15000 kPa and 30000 kPa.

6. The food formulation according to claim 1, wherein said vegetable fiber in a finely divided form is selected from the group comprising citrus fiber, apple fiber, pea fiber, potato fiber, carrot fiber and rice fiber, and has an average particle size less than or equal to 1500 μm.

7. The food formulation according to claim 1, wherein said oleaginous seed in a finely divided form is selected from the group consisting of almond, cashew, pistachio, hazelnut, walnut, pecan nut, macadamia nut, pine nuts, hemp seeds, sunflower seeds, pumpkin seeds, flax seeds, peanuts, and chia seeds, and has an average particle size equal to or less than 1500 μm.

8. The food formulation according to claim 1, wherein said vegetable fiber is citrus fiber, and said oleaginous seed is cashew.

9. The food formulation according to claim 1, wherein said vegetable fiber is apple fiber, and said oleaginous seed is almond.

10. The food formulation according to claim 1, wherein said vegetable in a finely divided form is selected from the group consisting of basil, parsley, thyme, marjoram and oregano.

11. The food formulation according to claim 1, wherein said at vegetable in a finely divided form is present in a quantity of between 10% and 15% by weight of the total weight of the formulation and has an average particle size equal to or less than 1500 μm.

12. The food formulation according to claim 1, wherein said vegetable oil is selected from the group consisting of sunflower oil, corn oil, rice oil, sesame oil, peanut oil and olive oil.

13. The food formulation according to claim 12, wherein said vegetable oil is present in a quantity between 10% and 15% by weight of the total weight of the formulation.

14. The food formulation according to claim 1, further comprising an ingredient selected from the group consisting of salt, sugars, starches, vegetable proteins, legumes, garden vegetables, leafy greens, cereals and natural flavourings.

15. The food formulation according to claim 1, further comprising an acidifying ingredient selected from the group consisting of citrus juices and vinegar.

16. A food formulation according to claim 1, wherein said food formulation has a rotational viscosity greater than 80 Pa·s, at a temperature of 22° C.

17. A food formulation according to claim 1, wherein said food formulation has a pH of between 3.0 and 5.0.

18. A food formulation according to claim 1 wherein said food formulation has a value of water activity (a_{w}) greater than or equal to 0.95.

19. The food formulation according to claims 1, wherein said food formulation is storable at a temperature of between 2° C. and 30° C. for a time period of at least two weeks.

20. (canceled)

21. The food formulation according to claim 1, wherein the modal diameter of the particles contained in said formulation is between 700 and 900 micrometers.

22. The food formulation according to claim 1, wherein said vegetable in a finely divided form is basil.

23. The food formulation according to claim 1, wherein said vegetable oil is extra virgin olive oil.

24. The food formulation according to claim 1, wherein said vegetable oil is sunflower oil.

25. The food formulation according to claim 1, wherein the food formulation has a rotational viscosity greater than 115 Pa·s at a temperature of 22° C.

26. The food formulation according to claim 1, wherein the food formulation has a pH of between 3.5 and 3.9.

27. The food formulation according to claim 1, wherein the food formulation has a value of water activity (a_{w}) of between 0.95 and 0.99.

28. The food formulation according to claim 1, wherein said food formulation is storable at a temperature of between 2° C. and 30° C. for a time period of 24 months.
